(19) United States
(12) Patent Application Publication
(10) Pub. No.: US 2020/0052996 A1
(43) Pub. Date: Feb. 13, 2020

(54) CONSENSUS INCENTIVE METHOD FOR BLOCKCHAIN

(71) Applicant: SPACEBOOK TECHNOLOGY CO. LIMITED, Road Town (VG)

(72) Inventors: DAXIN ZHU, SHENZHEN (CN); YU WANG, SHENZHEN (CN)

(21) Appl. No.: 16/243,745

(22) Filed: Jan. 9, 2019

(30) Foreign Application Priority Data
Aug. 9, 2018 (CN) 201810904007.4

(51) Int. Cl. H04L 12/26; H04L 29/08

(52) U.S. Cl. CPC H04L 43/50; H04L 67/104; H04L 43/08

(57) ABSTRACT

A consensus incentive method for a blockchain is provided. The consensus incentive method include rewarding nodes correspondingly according to amounts of network data transmitted by the respective nodes in a blockchain network. Therefore, problems of waste of resources, centralized calculation power and huge cost of dedicated mining machines caused by the existing Pow mechanism can be avoided consequently.

### FIELD OF THE DISCLOSURE

The disclosure relates to the field of blockchain technologies, and more particularly to a consensus incentive method for a blockchain.

### BACKGROUND

A blockchain is a distributed peer-to-peer network without a central control point and uses a distributed collective operation method to realize a tamper-resistant and trustworthy database technology solution. Its characteristics are decentralized storage, highly transparent information and difficult to be tampered, etc. In a blockchain system, for each user node, after the user node does a certain amount of work, the blockchain system will make a corresponding reward according to the amount of work.

The Proof-of-work (Pow) is originally an economics term, which refers to a measurement method that a system sets to achieve a certain goal. A simple understanding is a proof that confirms that you have done a certain amount of work. To monitor the entire process of monitoring is often extremely inefficient, but it is very efficient to prove a corresponding amount of work has been completed by certifying a result of work.

Generally speaking, the blockchain is a “public accounting book” that uses computer programs to record all transaction information across the network. Bookkeeping is a process of calculating flash and packing according to information such as transaction records, transaction times, book numbers and previous flash values.

During each time of bookkeeping, a Hash value of a previous block and a current book page information are used as original information for a Hash operation. If so, it is obvious that everyone can easily complete the bookkeeping. In order to ensure that only one person can do the bookkeeping in a given period of time (for example, about 10 minutes), it is necessary to increase the difficulty of bookkeeping, so that a result of the flash operation must start with several zeros. Meanwhile, in order to satisfy this condition, a random number variable is introduced in the Hash operation. In particular, in a process of the Hash operation, by constantly changing the value of a random number, you can always find a random number so that the result of the Hash operation starts with a few zeros, and the node which firstly finds the random number will get the sole rights for this time of bookkeeping.

A Hash value is a string consisted of numbers and uppercase as well as lowercase letters, each character thereof has 62 possibilities (possibly any one symbol of 26 uppercase letters, 26 lowercase letters and 10 numbers). Assuming that the probability of any symbol appearing is equal, the probability of the first character being zero is 1/62 (no matter what the other characters are). If the Hash value starts with 18 zeroes, you need to theoretically try the 18th power of 62 and thus this number is very huge. Such a large amount of calculation requires a large amount of computing equipment, power, and the like.

Nowadays, in the blockchain system, a mature Hashcash algorithm may include the following steps:

a. taking some public data (e.g., taking data of block header);

b. adding a counter to the public data, wherein the counter in default starts from 0 (the counter is a random number nonce in the blockchain);

c. combining the data and the counter together to get a Hash value;

d. checking if the Hash value meets certain conditions: if the conditions are met, ending the process; but if the conditions are not met, increasing the counter and repeating the steps c-d.

An original implementation of the Hashcash algorithm requires that the first 20 character of a Hash value must be zeros, but in the Bitcoin system, the number of zeros counted is dynamically changed to ensure that one block is generated every 10 minutes. During coding, it is needed to add the nonce to the public data (taking the block header) for doing the Hash operation, and then the result of the Hash operation is compared with a preset difficulty. If it is smaller than the difficulty, the operation is considered as correct.

As seen from the above, the conventional consensus incentive method for the blockchain has the following problems.

1. The calculation of Hash causes a lot of waste of resources. At present, Bitcoin has attracted most of the world's computing power, and thus it is difficult for other blockchain applications that use the Pow consensus mechanism to obtain the same computing power to protect their own security. This causes the mechanism based on fair distribution of rewards to evolve into a large investment in the calculating powers of mining machines, resulting in the original design intention is distorted.

2. The Pow consensus algorithm is centralized in computing power and gradually deviates from the original decentralized orbit. From the battle for Bitcoin expansion, it is seen that the large-scale mining pool with high computing power is the winner, holders of the Bitcoins do not have the rights to make decisions, therefore it will soon lose the label of “decentralization”.

3. The emergences of expensive specialized mining machines and specialized mines have brought about a huge crisis to the entire Bitcoin ecosystem; the development of dedicated chips requires enormous money, the production of mining machines requires enormous money, the deployment and operation of mining machines require enormous money (taking today's 300P in an entire network, the average power consumption is 1 G/W, and if the average cost is 0.5 Yuan/kW·h, the daily operating electricity expenditure is 3.6 million Yuan of RMB, so that the annual electricity cost is 1.3 billion Yuan), moreover, the sale of mining machines is based on the amount of Bitcoins produced in the future and then discounted to miners. By withdrawing a large amount of money from the system, miners must make sure the growth of gambling difficulty as required is lower than expected, so that enough profits can be obtained based upon the rising of the price of Bitcoin.

In view of the aforesaid problems in related art, there is no effective solution has been proposed yet.

### SUMMARY

In view of the above issues in the related art, the disclosure provides a consensus incentive method for a blockchain to avoid the problems caused by Pow mechanism.

Technical solutions of the disclosure are embodied as follows

According to an aspect of the disclosure, a consensus incentive method for a blockchain, includes:

rewarding nodes correspondingly according to amounts of network data transmitted by the respective nodes in a blockchain network.

According to an embodiment of the disclosure, the consensus incentive method further includes: sending network data to a client node from a corresponding storage node, in response to a request sent from the client node, wherein the nodes include the client node and the storage node, and recording an amount of network data received by the client node and an amount of the network data sent from the storage node.

According to an embodiment of the disclosure, the consensus incentive method further includes: sending network data to the client node from a network host node for acceleration, in response to the request sent by the client node, wherein the nodes include the network host node, and recording an amount of the network data sent from the network host node.

According to an embodiment of the disclosure, the consensus incentive method further includes: allocating a plurality of storage nodes in response to the request sent from the client node, and designating one of the plurality of storage nodes as a target storage node and the remaining of the plurality of storage nodes as an intermediate storage node(s); and sending a task request to the target storage node through the intermediate storage node(s).

According to an embodiment of the disclosure, the consensus incentive method further includes: sending network data to a task source node through the intermediate storage node(s), from the target storage node.

According to an embodiment of the disclosure, before sending a task request to the target storage node through the intermediate storage node(s), the consensus incentive method further includes: sending a relay task request to each the intermediate storage node, wherein the relay task request comprises s a source address and a target address of a relay task; and sending a download task request to the target storage node, wherein the download task request includes a source address of a task.

According to an embodiment of the disclosure, the consensus incentive method further includes: selecting a plurality of network host nodes to form a test group, wherein the nodes further include the plurality of network host nodes; and assigning a same test task to the plurality of network host nodes in the test group, so as test amounts of network data downloaded by a storage node to be tested.

According to an embodiment of the disclosure, after assigning a same test task to the plurality of network host nodes in the test group, the consensus incentive method further includes: returning amounts of network data downloaded by the storage node to be tested, by the plurality of network host nodes respectively, after the plurality of network host nodes in the test group finish the test task, and determining whether the storage node to be tested is cheating according to the amounts of network data returned by the plurality of network host nodes.

According to an embodiment of the disclosure, each of the plurality of network host nodes in the test group tests the amount of the network data downloaded by the storage node to be tested, through an unperceived inspection mechanism.

Sum up, the above technical solutions of the disclosure use throughput as a measure of a work contribution of the node of the blockchain. Compared with the related art, problems of waste of resources, centralized calculation power and huge cost of dedicated mining machines caused by the existing Pow mechanism can be avoided. Moreover, the process of using multiple nodes to participate in the data transmission can avoid a joint cheating between a single storage node and the client node. In addition, through an inspection mechanism, it can determine whether the node to be tested is cheating or not. Furthermore, through an unperceived inspection mechanism, a joint cheating between nodes participated in the inspection process can be avoided.

### BRIEF DESCRIPTION OF THE DRAWINGS

In order to more clearly illustrate embodiments of the disclosure or the technical solutions in related art, drawings used in the embodiments will be briefly introduced below. Apparently, the drawings in the description below are merely some embodiments of the disclosure, a person skilled in the art can obtain other drawings according to these drawings without creative efforts. In the figures:

FIG. 1 is a schematic view of network topology of multiple nodes associated with a consensus incentive method according to an embodiment of the disclosure;

FIG. 2 is a flowchart associated with a C node in FIG. 1 initiating a download task;

FIG. 3 is a flowchart of multiple PP nodes participating in a process of relaying data according to an embodiment of the disclosure; and

FIG. 4 is a flowchart of an inspection mechanism associated with a consensus incentive method according to an embodiment of the disclosure.

### DETAILED DESCRIPTION OF EMBODIMENTS

Technical solutions of embodiments of the disclosure will be clearly and fully described in the following with reference to the accompanying drawings in the embodiments of the disclosure. Apparently, the described embodiments are some of the embodiments of the disclosure, but not all of the embodiments. All other embodiments obtained by skilled person in the art based on the described embodiments of the disclosure are within the scope of protection of the instant application.

According to an embodiment of the disclosure, the disclosure provides a consensus incentive method for a blockchain. The consensus incentive method includes: rewarding nodes correspondingly according to amounts of network data transmitted by the respective nodes in a blockchain network. Through the above technical solution of the disclosure, a work proof based on throughput is provided. Based upon the network data throughput between multiple nodes in the blockchain network, working capacity and workload of each node are determined, so that the behavior of work done is rewarded accordingly. Compared with the related art, problems of waste of resources, centralized calculation power and huge cost of dedicated mining machines caused by the existing Pow mechanism can be avoided consequently.

In an embodiment, the consensus incentive method of the disclosure may further include: sending network data to a client node from a corresponding storage node, in response to a request sent from the client node, wherein the nodes include the client node and the storage node; and recording an amount of network data received by the client node and an amount of the network data sent from the storage node.

The consensus incentive method of the disclosure may further include: sending network data to the client node from a network host node for acceleration, in response to the request sent from the client node, wherein the nodes include the network host node; and recording an amount of the network data sent from the network host node.

FIG. 1 shows a schematic view of network topology of multiple nodes associated with a consensus incentive method according to an embodiment of the disclosure. The multiple nodes include SP nodes (management nodes), PP nodes (storage nodes), P nodes (network host nodes) and a C node (client node). Functions of the respective types of nodes arc explained as follows. The C node is an ordinary user node and is a user for file uploading and downloading. The P node is a network hast node for providing underlying file access and uplink bandwidth traffic sharing. The PP node is used to complete a file storage task, provide a stable and fast file access acceleration service, assign a file storage task to the P node and perform node management. The SP node is used for scheduling of store task, address mapping of file leading, fully synchronizing of PP stale information in the SP node, and storing and backing up of storage index relationship information of file in a SP node cluster.

It should be understood that a throughput calculation refers to defining a calculation period and counting an amount of network data transmitted by each node. If a first node A sends a network data amount M to a second node B, the M is a contribution value provided by the first node A.

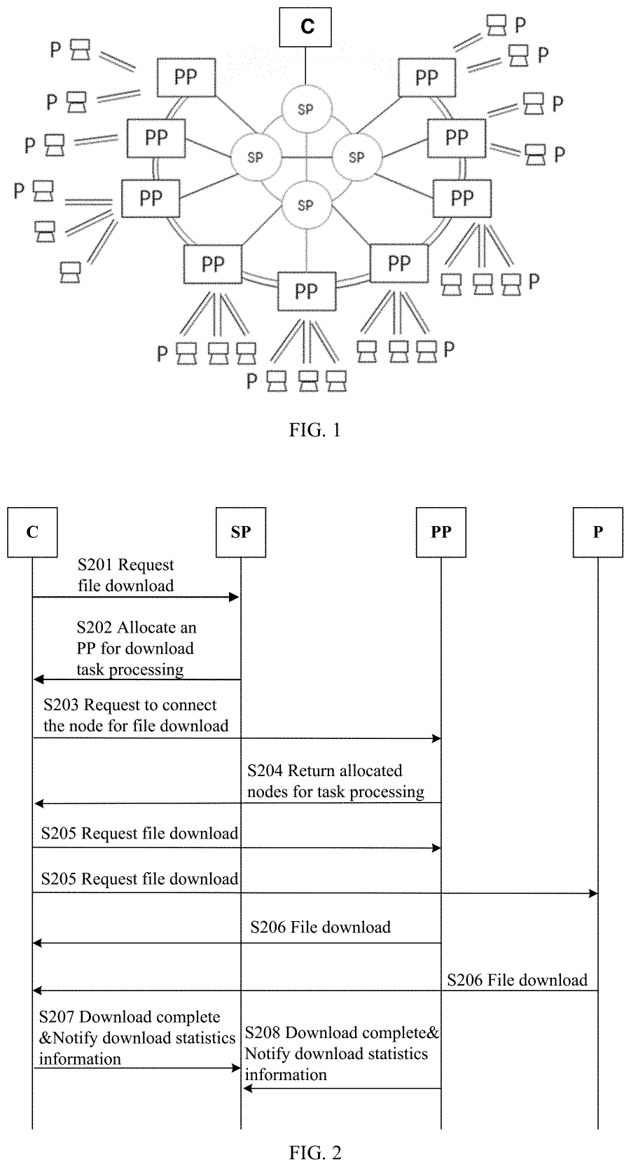

As shown in FIG. 2, a flowchart associated with the C node in FIG. 1 initiating a download task is shown. In particular, the C node initiates a download task, and the PP node and the P node respectively provide partial task file content transmission to the C node. In this process, the data amounts sent by the PP node and the P node ate their throughputs respectively. It should be understood that, the illustration of FIG. 1 and FIG. 2 only is an exemplary embodiment of the nodes connection mode and the network data transmission mode, and does not constitute any limitation to the disclosure. It also should be understood that, in the embodiment shown in FIG. 1 to FIG. 4, the other nodes arc managed by the SP node, such as task scheduling, but according to actual applications, other implementable modules may also be used to manage the nodes. This disclosure does not limit this.

Specifically, as shown in FIG. 2, at a step S201, the C node initiates a connection request to the SP node and requests to download a certain file after the connection is successful.

At a step S202, after receiving the request task of the C node, the SP node queries whether the system has the file, and if so, allocates a PP node for processing the download task and sends connection information (such as IP address and port, etc.) of the PP node to the C node.

At a step S203, after retching the connection information of the PP node sent by the SP node, the C node sends a connection request to the PP node. After the connection is successful, the C node requests to download the file.

At a step S204, after receiving the download request of the C node, the PP node returns connection information of a PP node for actually providing download and connection information of an acceleration P node to the C node.

At a step S205, the C node issues connections to the received processing nodes, and requests to download relevant file blocks from the PP node and the P node.

At a step S206, the PP node and the P node transmit file contents to the C node according to the requests of the C node.

At a step S207, after the C node completes the download of the file, the SP node is notified with download task related statistical information. The statistical information includes amounts of downloaded data provided by the respective download nodes.

At a step S208, the PP node connects to the SP node and notifies the SP node with download task related statistical information.

Then, the SP node records traffic information of the download task uploaded by the C node, the FP node and the P node, and registers the node throughput records that provide download traffics.

In the download process shown in FIG. 2, the C node requests to download the specified file, and there is a possibility of joint cheating between the C node and the file providing node PP. For example, the C node requests to download the file, but the PP node does not actually send the file to the C node, and then both the C node and the PP node actively notify the SP node that the file has been successfully downloaded and a certain amount of file has been provided, so as to cheat traffic revenue. In order to prevent the occurrence of such a cheating process, the disclosure further designs a data relaying process of multiple nodes, and thereby increases the cost of joint cheating between the C node and the PP node through the participation of multiple nodes. Because multiple nodes relaying data needs to join multiple PP nodes, and the PP nodes are randomly allocated, there are uncertainties.

In an embodiment, the consensus incentive method of the disclosure further include following steps of: allocating multiple storage nodes in response to the request sent from the client node and designating one of the multiple storage nodes as a target storage node and the remaining of the multiple storage nodes as an intermediate storage node(s); and sending a task request to the target storage node through the intermediate storage node(s).

Before sending a task request to the target storage node through the intermediate storage node(s), the consensus incentive method may further include: sending a relay task request to each the intermediate storage node, wherein the relay task request comprises a source address and a target address of a relay task; and sending a download task request to the target storage node, wherein the download task request comprises a source address of a task.

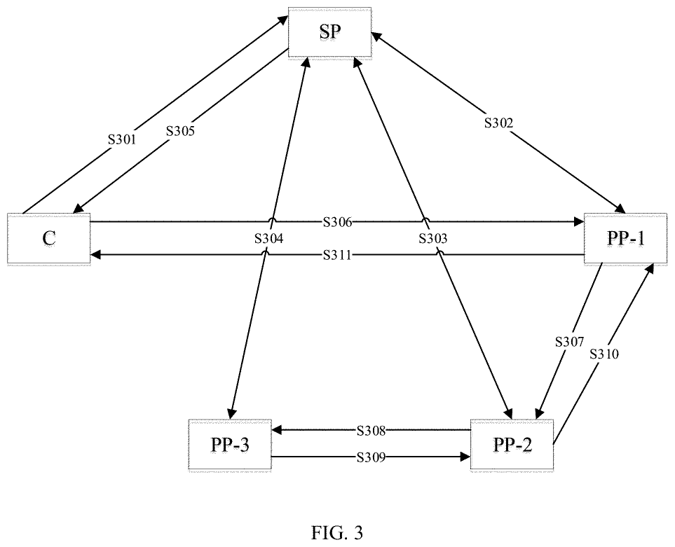

The illustrated embodiment of the disclosure uses multiple PP nodes to participate in data transmission and relay, and thus can avoid the joint cheating of PP node and C node. FIG. 3 shows a flowchart of multiple PP nodes participating in data relaying.

At a step S301, the C node connects to the SP node, and after the connection is successful, the C node issues a data download request to the SP node.

At a step S302, after receiving the request, the SP node generates a task identification (id), and allocates three PP nodes (i.e., PP-1 node, PP-2 node and PP-3 node) to process data. The PP-3 node is a node stored with a target file PP-1 node and PP-2 node are intermediate forwarding/relaying nodes. The SP node sends a relay download task request (carrying the task id) to the PP-1 node so as to indicate that a source address of the task is the C node, and the forwarded target node is the PP-2 node. The PP-1 node returns that the request has been received.

At a step S303, the SP node sends a relay download task request (carrying the task id) to the PP-2 node so as to indicate that the source address of the task is the PP-1 node, and the forwarded target node is the PP-3 node. The PP-2 node returns that the request has been received.

At a step S304, the SP sends a download file task request (carrying the task id) to the PP-3 node so as to indicate that the source address of the task is the PP-2 node. The PP-3 node returns that the request has been received.

At a step S305, after receiving successful responses of all the PP nodes, the SP node returns node information of the PP-1 node and the task id to the C node.

At a step S306, the C node sends a file download task request (carrying task id) to the PP-1 node.

At a step S307, after receiving the download task request of the C node, the PP-1 node forwards information to the PP-2 node.

At a step S308, after receiving the download task request of the C node, the PP-2 node forwards information to the PP-3 node.

At a step S309, the PP-3 node transmits file content to the PP-2 node.

At a step S310, the PP-2 node forwards the file content to the PP-1 node.

At a step S311, the PP-1 node forwards the file content to the C node.

The throughput for the node is evidenced by the traffic service the node provides. Work tasks are issued by other management node (such as the SP node), and the PP node itself cannot generate traffic. Whether the workload is up to standard is verified by the SP node and the C node of final consumer. In a statistical flow of the throughput traffic, there may be inconsistent traffic data reported by the PP node and the C node. For example, after the C node requests the download and the PP node provides the download, the C node and the PP node jointly report the workload to the SP node, and the C node and the PP node may submit conflicting data. In order to identify which node is wrong, the disclosure proposes a following inspection mechanism.

In an embodiment, the consensus incentive method may further include: selecting multiple network host nodes to form a test group, wherein the nodes further include the multiple network host nodes; and assigning a same test task to the multiple network host nodes in the test group, so as test amounts of network data downloaded by a storage node to be tested.

After assigning a same test task to the multiple network host nodes in the test group, the consensus incentive method may further include: returning amounts of network data downloaded by the storage node to be tested, by the multiple network hast nodes respectively, after the multiple network host nodes in the test group finish the test task; and determining whether the storage node to be tested is cheating according to the amounts of network data returned by the multiple network host nodes.

Moreover, each of the multiple (i.e., more than one) network host nodes in the test group tests the amount of the network data downloaded by the storage node to be tested, through an unperceived inspection mechanism. It should be understood that, the unperceived inspection mechanism means that for each network host node in the test group, each network host nixie does not know that it is a test inspection node. That is, for each inspection node in the test group, when the inspection task is assigned, a file download process corresponding thereto is the same as ordinary user's file download process. In this way, it avoids the joint cheating of the test inspection nodes (i.e., the network host nodes in the test group).

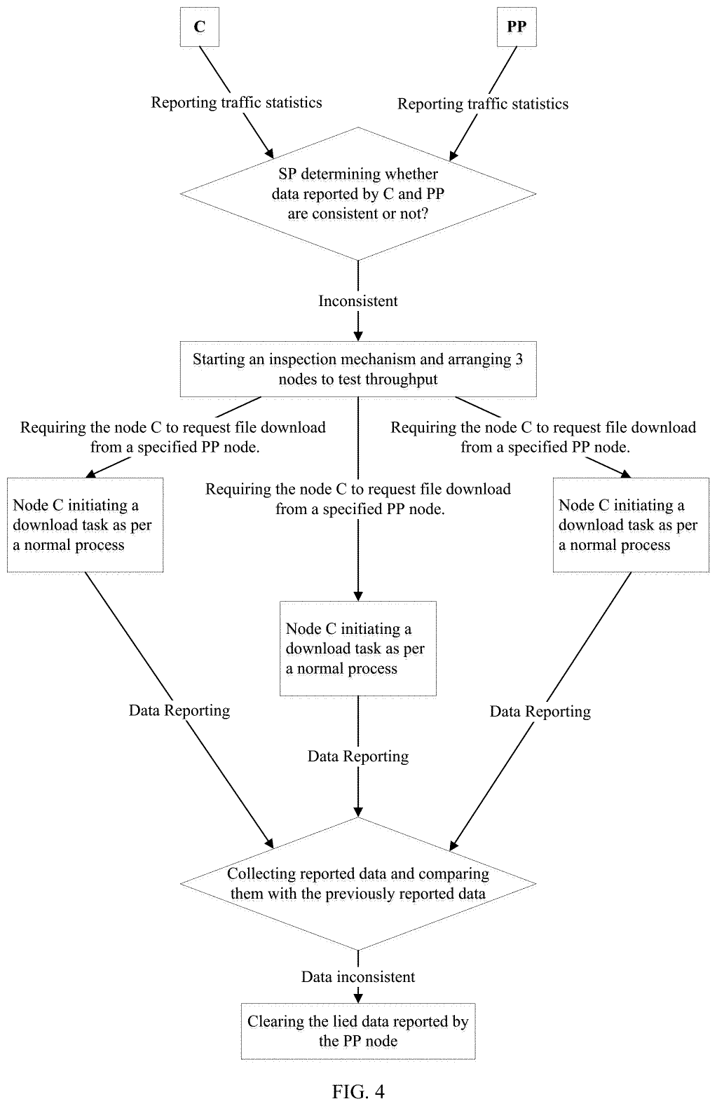

FIG. 4 shows a flowchart associated with an inspection mechanism of the disclosure. Referring to FIG. 4, the SP node selects several P nodes to form a test group within a certain time or range. Preferably, P nodes located in dispersed areas are selected to form the test group. Optionally, an amount of the P nodes in the test group is greater than or equal to 3. Then, the test group is assigned with a test task, and the SP node assigns the same test task to each P node in the test group to test a download throughput of a same file by a same PP node. After the test task is completed by the test group, download statistics information are submitted to the SP node. After comparing all the download statistics information, a test result returned by most of the P nodes is selected as a reasonable test result. The selected test result is used as a reference standard to compare the statistical information of the download task previously submitted by the PP node to determine whether the PP node has a cheating behavior.

In summary, the above technical solutions of the disclosure use throughput as a measure of work contribution of any one node of the blockchain. Compared with the related art, problems of waste of resources, centralized calculation power and huge cost of dedicated mining machines caused by the existing Pow mechanism can be avoided. Moreover, the process of using multiple nodes to participate in the data transmission can avoid the joint cheating between the single storage node and the client node. In addition, through the inspection mechanism, it can determine whether the node to be tested is cheating or not. Furthermore, through the unperceived inspection mechanism, the joint cheating among the inspection nodes can be avoided.

The foregoing are only illustrated embodiments of the disclosure and not intended to limit the disclosure Any modifications, equivalent substitutions, improvements, etc., made within the spirit and scope of the disclosure, should be included in the protection scope of the application.

What is claimed is:

1. A consensus incentive method for a blockchain, comprising:
rewarding nodes correspondingly according to amounts of network data transmitted by the respective nodes in a blockchain network.

2. The consensus incentive method as claimed in claim 1, further comprising:
sending network data to a client node from a corresponding storage node, in response to a request sent from the client node, wherein the nodes comprise the client node and the storage node; and
recording an amount of network data received by the client node and an amount of the network data sent from the storage node.

3. The consensus incentive method as claimed in claim 2, further comprising:
sending network data to the client node from a network host node for acceleration, in response to the request sent from the client node, wherein the nodes comprise the network host node;
recording an amount of the network data sent from the network host node.

4. The consensus incentive method as claimed in claim 2, further comprising:
allocating a plurality of storage nodes in response to the request sent from the client node, and designating one of the plurality of storage nodes as a forget storage node and the remaining of the plurality of storage nodes as an intermediate storage node(s);
sending a task request to the target storage node through the intermediate storage node(s).

5. The consensus incentive method as claimed in claim 4, further comprising:
sending network data to a task source node through the intermediate storage node(s) from the target storage node.

6. The consensus incentive method as claimed m claim 5, before sending a task request to the target storage node through the intermediate storage node(s), further comprising:
sending a relay task request to each the intermediate storage node, wherein the relay task request comprises a source address and a target address of a relay task;
sending a download task request to the target storage node, wherein the download task request comprises a source address of a task.

7. The consensus incentive method as claimed in claim 2, further comprising:
selecting a plurality of network host nodes to form a test group, wherein the nodes further comprise the plurality of network host nodes;
assigning a same test task to the plurality of network host nodes in the test group, so as test amounts of network data downloaded by a storage node to be tested.

8. The consensus incentive method as claimed in claim 7, after assigning a same test task to the plurality of network host nodes in the test group, further comprising:
returning amounts of network data downloaded by the storage node to be tested, by the plurality of network host nodes respectively, after the plurality of network host nodes in the test group finish the test task;
determining whether the storage node to be tested is cheating according to the amounts of network data returned by the plurality of network host nodes.

9. The consensus incentive method as claimed in claim 7, wherein each of the plurality of network host nodes in the test group tests the amount of the network data downloaded by the storage node to be tested, through an unperceived inspection mechanism.
